(19) United States
(12) Patent Application Publication
(10) Pub. No.: US 2007/0103917 A1
(43) Pub. Date: May 10, 2007

(54) Lighting fixture

(75) Inventors: Ching-Yi Wu, Ping Cheng City (TW); Chien-Ching Yang, Ping Cheng City (TW); Chih-Ming Chen, Ping Cheng City (TW); Yu-Fang Huang, Ping Cheng City (TW)

Correspondence Address: TROXELL LAW OFFICE PLLC, SUITE 1404, 5205 LEESBURG PIKE, FALLS CHURCH, VA, 22041, US

(73) Assignee: Kenly Precision Industrial Co., Ltd.

(21) Appl. No.: 11/269,725

(22) Filed: Nov. 9, 2005

(51) Int. Cl. F21V 21/096; F21V 21/30; F21L 4/04

(52) U.S. Cl. 362/398; 362/427; 362/430; 362/191

(57) ABSTRACT

A lighting fixture includes a body and a light emitting unit; the body being provided with a magnetic attraction device comprised a magnetic member with permanent permeability and a control member to control direction of magnetic filed lines from the magnetic member for it to provide attraction force or not; the lighting fixture being attached to a metallic surface when attraction force is provided or disengaged from the metallic surface by changing the direction of those magnetic force lines in the magnetic member.

### BACKGROUND OF THE INVENTION

(a) Field of the Invention

The present invention is related to a lighting fixture, and more particularly, to one that can be attached to metallic surface (e.g., refrigerator, metal door panel) for fast and easy access.

(b) Description of the Prior Art

A lighting fixture (e.g., a flashlight) usually becomes handy in case of power failure or at where city power fails to reach. In case of a power failure, it takes the lighting fixture to help the repair job. As illustrated in FIG. 1 of the accompanying drawings, one has to bit a lighting fixture 1, a flashlight in this case since he has to use both hands to work. If the repair job can be done in a short while, it's OK to bite the flashlight though it presents health problem; however, the job could go longer and must be interrupted as one's mouth getting sour by holding the flashlight in his mouth.

### SUMMARY OF THE INVENTION

The primary purpose of the present invention is to provide a lighting fixture that can be easily attached to metallic surface (e.g., refrigerator or metal door panel) for fast and convenient access.

To achieve the purpose, the lighting fixture of the present invention includes a light emitting unit and a body. The body contains a cabinet to accommodate one or multiple cells to supply power to the light-emitting unit. A magnetic attraction device is disposed at where appropriately on the body and includes a magnetic member, a magnetism permeable member, a non-magnetism permeable member, and a control member. The magnetic member carries permanent magnetism. The control member controls the direction of those magnetic filed lines from the magnetic member to determine if the magnetism permeable member to carry magnetic force or not. When provided with magnetic force, the magnetism permeable member allows the lighting fixture to be attracted and held steady to a metallic surface (e.g., refrigerator, metal door panel); and the control member shifts the direction of those magnetic field lines to deprive the magnetism permeable member of magnetic attraction force for the lighting fixture to fast and easily disengage from the metal surface.

### BRIEF DESCRIPTION OF THE DRAWINGS

FIG. 1 is a schematic view showing an operating status of a lighting fixture of the prior art.

FIG. 2 is an exploded view of a first preferred embodiment of the present invention.

FIG. 3 is an exploded view of a second preferred embodiment of the present invention.

FIGS. 4A and 4B are a schematic views of a construction of a magnetic attraction device of the present invention.

FIG. 5 is a schematic view showing an operating status of a lighting fixture of the present invention.

FIG. 6 is a schematic view showing another construction of magnetic attraction device of the present invention.

FIG. 7 is a perspective view of a third preferred embodiment of the present invention.

FIGS. 8 (A), (B), ad (C) are schematic views showing that the lighting fixture of the present invention is attached to a metallic surface.

FIG. 9 is a perspective view of a fourth preferred embodiment of the present invention.

FIG. 10 is a perspective view showing that the fourth preferred embodiment is attached to a helmet.

FIG. 11 is a perspective view of a fifth preferred embodiment of the present invention.

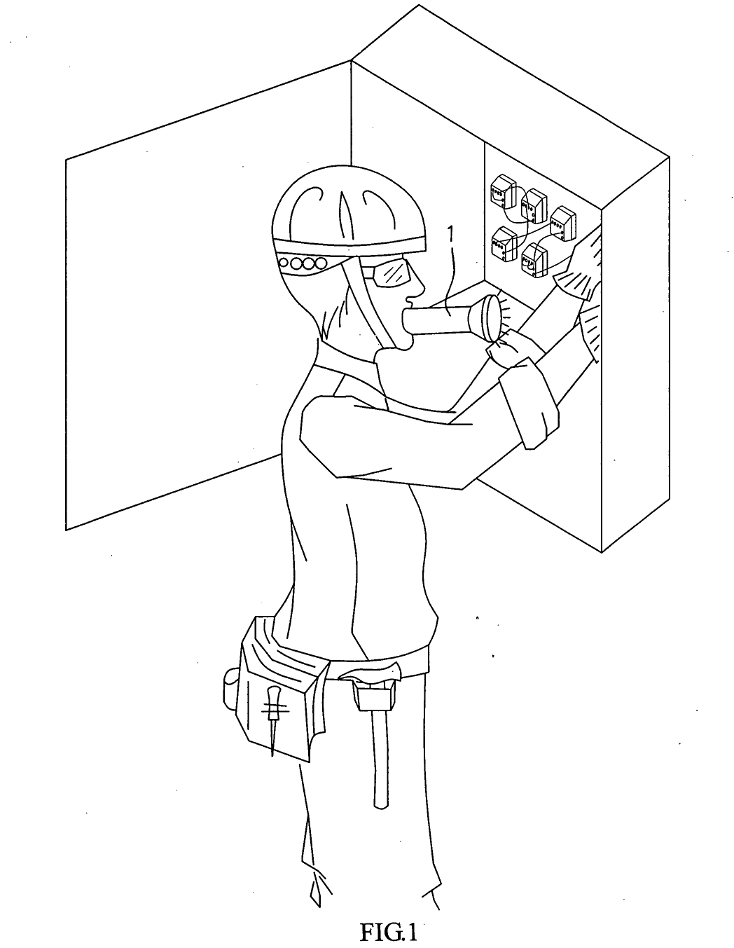

### DETAILED DESCRIPTION OF THE PREFERRED EMBODIMENTS

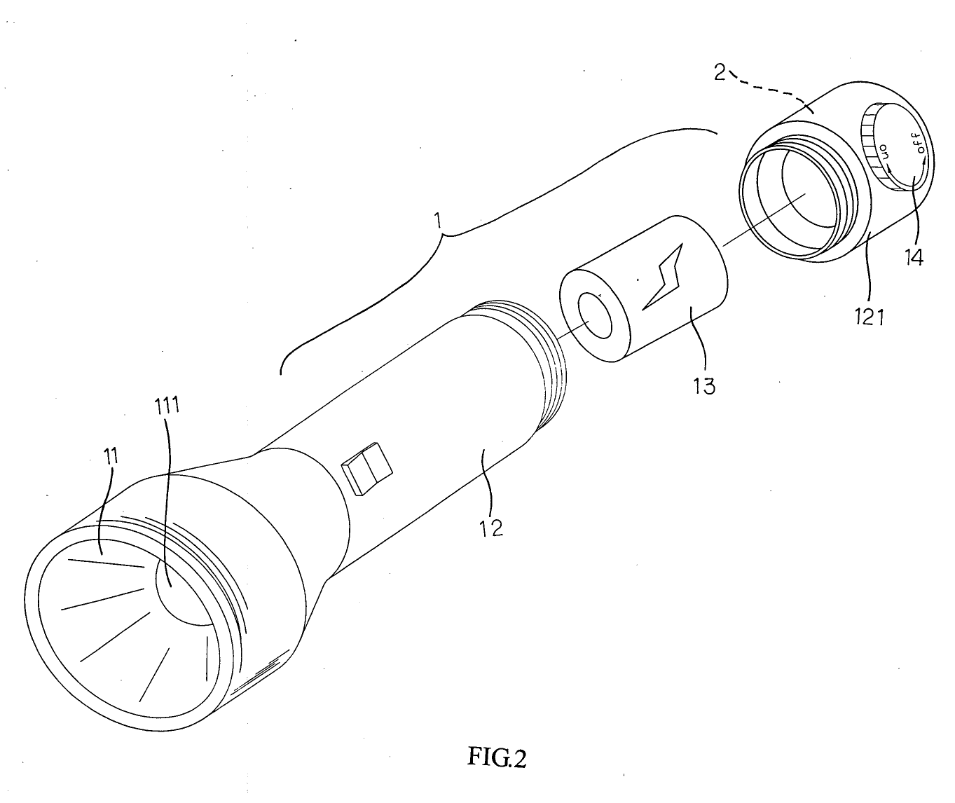

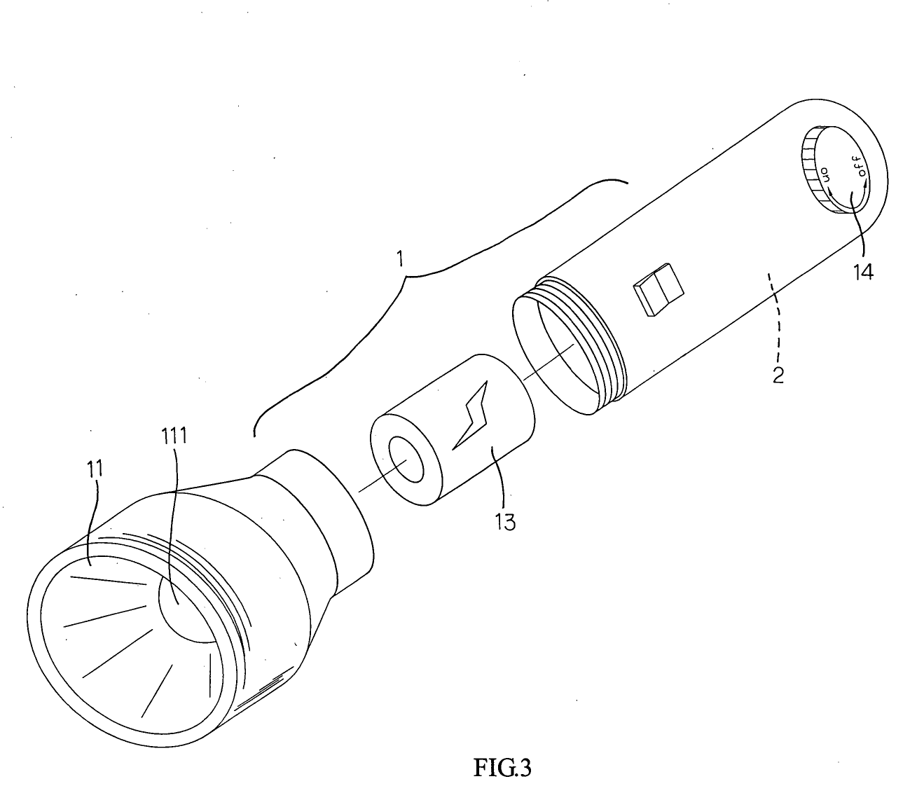

Referring to FIG. 2 for a construction of a lighting fixture 1, which in the preferred embodiment related to a flashlight includes a light emitting unit 11 and a holder 12. The light-emitting unit 11 is located at the head cap of the holder 12 of the lighting fixture to respectively provide front light emission. The holder 12 contains a cell 13 to supply power to a light-emitting device 111 disposed at the light-emitting unit 11. The tail of the holder 12 is related to a threaded bottom cap 121 and a magnetic attraction device 2 is provided to the bottom cap 121. Alternatively, the magnetic attraction device 2 is made as an integrated with the tail of the holder 12 as illustrated in FIG. 3.

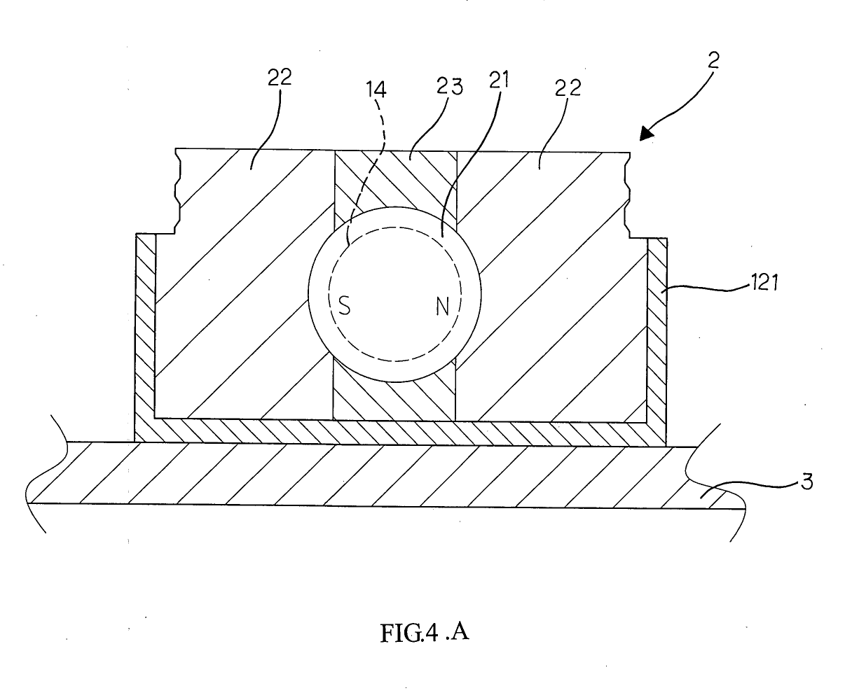

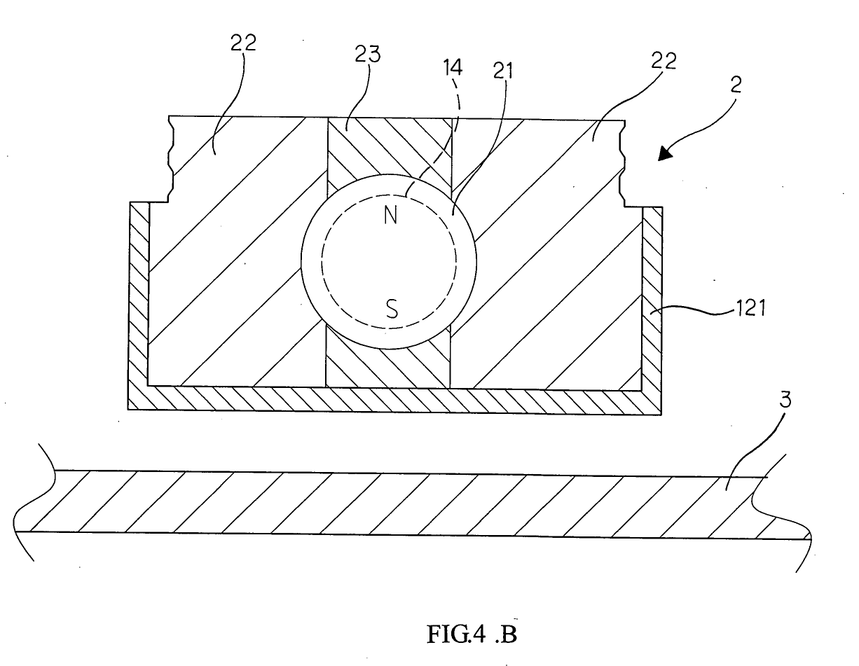

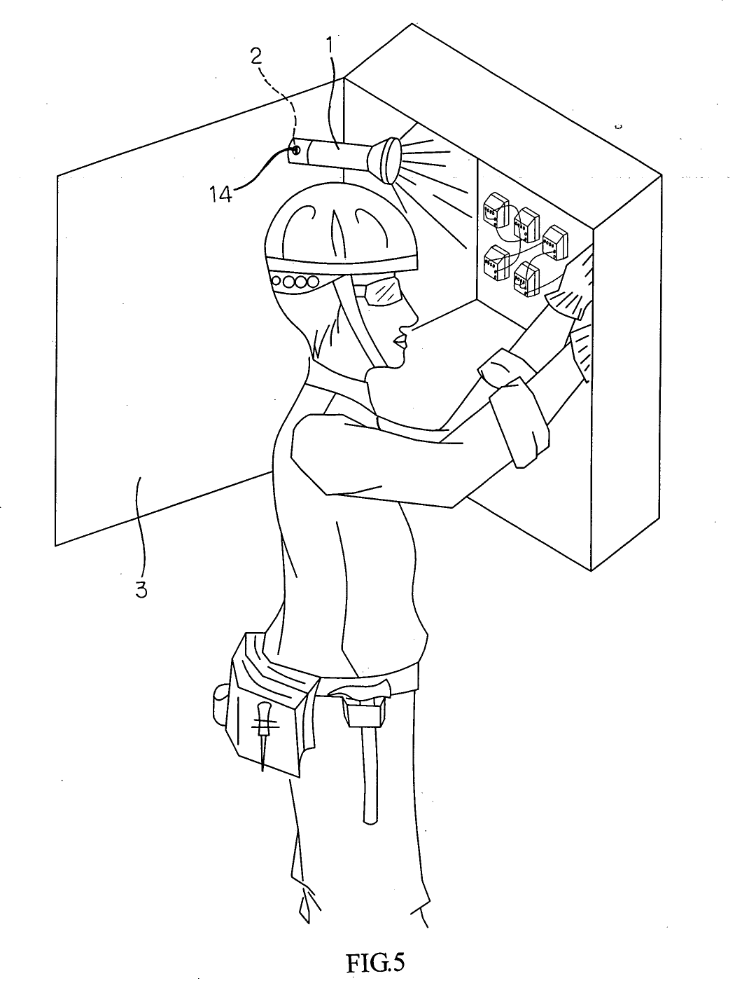

Now referring to FIG. 4(A), the magnetic attraction device 2 includes magnetic member 21, magnetism permeable member 22, non-magnetism permeable member 23, and control member 24. Wherein, the non-magnetism permeable member 23 is provided between two magnetism permeable members 22 to set them apart. The magnetic member 21 provided with permanent magnetism is also disposed between those two magnetism permeable members 22 with the size of the magnetic member 21 in such extent that it extends further into both magnetism permeable members 22. The control member 24 is fixed to the holder 12 or a knob 14 disposed externally to the bottom cap 121.

Whereas the magnetic member 21 is inherited with the positive pole N and the negative S, it provides multiple closed magnetic force lines from N pole to S pole. When both N and S poles of the magnetic member 21 respectively contact those two magnetism permeable members 22. That is, those magnetic force lines cross over both magnetism permeable members 22 for the latter to carry magnetic force. Accordingly the lighting fixture 1 attracts a metallic surface 3 (e.g., refrigerator or metal door panel) as illustrated in FIG. 5 to provide lighting for one to carry on certain service work. By rotating the knob 14 to control the turning of the magnetic member 21 to change the direction of those magnetic force lines as illustrated in FIG. 4(B), both magnetism permeable members 22 are deprived of the magnetic force to allow easy disengagement of the lighting fixture from the metallic surface.

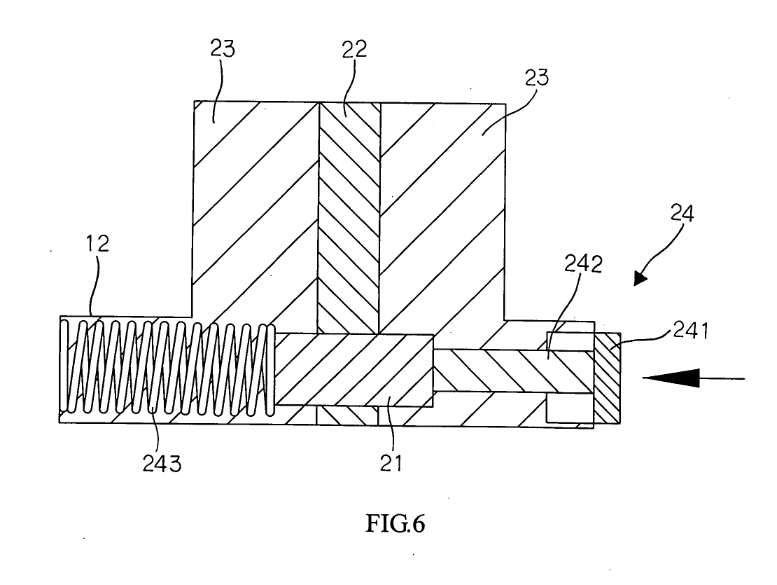

Alternatively, the magnetism permeable member 22 of the magnetic member 2 is disposed between two non-magnetism permeable members 23 to separate them apart from each other as illustrated in FIG. 6 with the magnetic member 21 placed at where closer to the magnetism permeable member 22. The control member 24 includes a push key 241, a push rod 242 and a coil 243 externally disposed to the holder 12. One end of the push rod 242 is connected to the push key 241 and another end of the push rod 242 is connected to the magnetic member 21 leaving the coil 243 mounted to the magnetic member 21 on the opposite side corresponding to where the push rod 242 is located. By pressing the push key 241 to subject the magnetic member 21 to be transposed by the push rod 242 to laterally travel between both non-magnetism permeable members 23 and the magnetism permeable member 22. Once the magnetic member 21 is fully moved to fall within the region covered by both non-magnetism permeable members 23 to clear from the magnetism permeable member 22, the magnetism permeable member 22 is deprived for magnetic force thus to allow the lighting fixture 1 to disengage from the metallic surface.

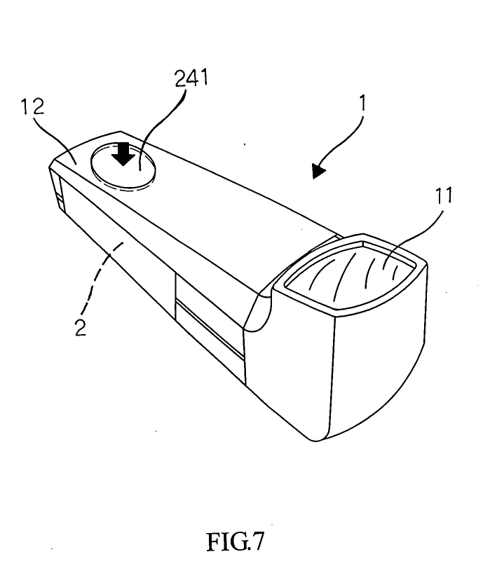

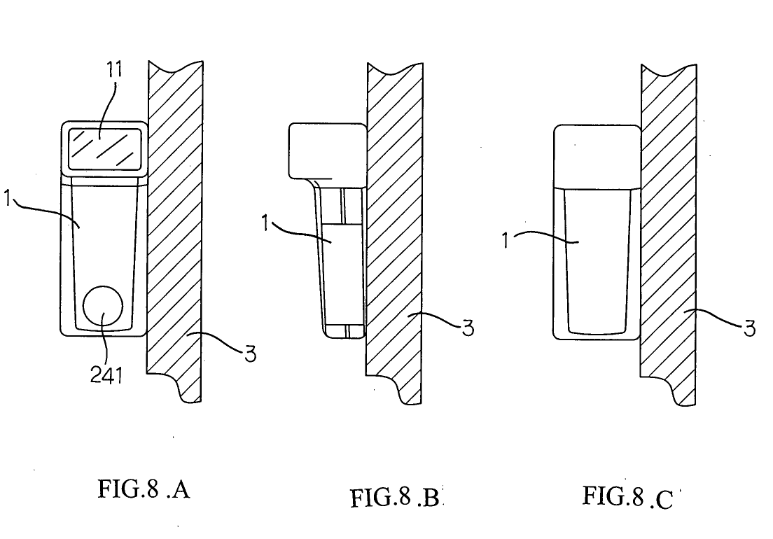

The light-emitting unit 11 is optionally disposed on one side of the holder to emit light from one side of the lighting fixture 1 as illustrated in FIG. 7. Meanwhile, the magnetic attraction device 2 may be provided on one side of the holder 12 to permit the lighting fixture 1 to attract onto the metallic surface 3 as illustrated in FIGS. (A), (B), and (C).

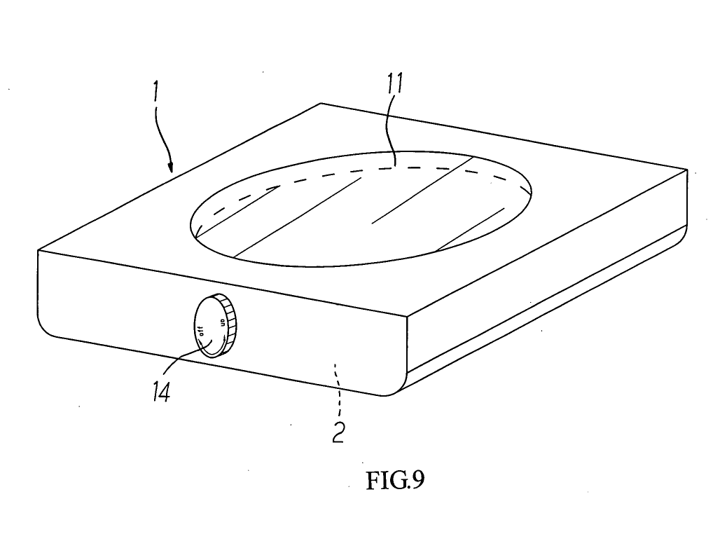

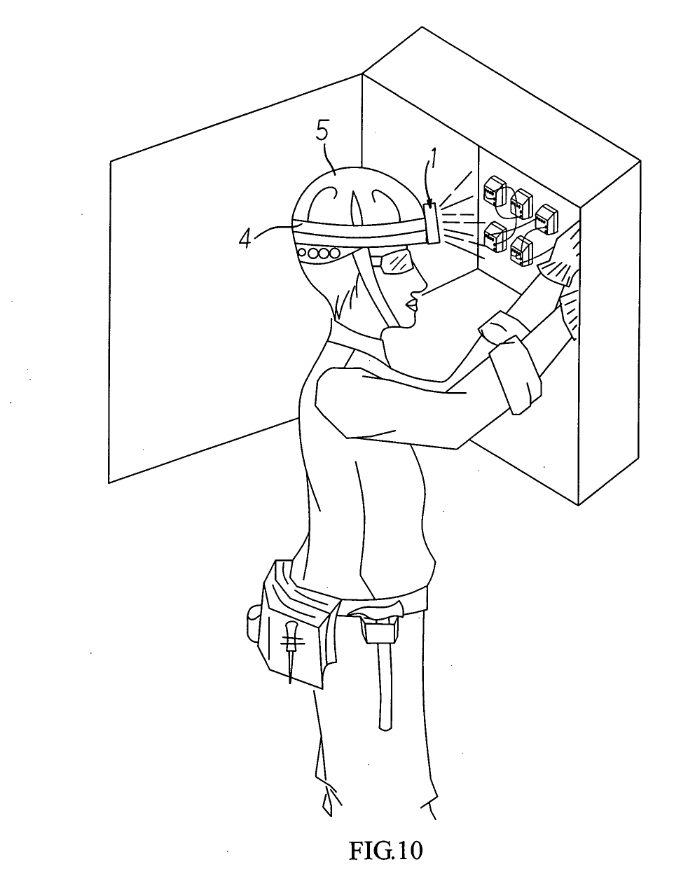

Furthermore, the lighting fixture 1 is made in a square form as illustrated in FIGS. 9 and 10. Wherein, the light-emitting unit 11 is disposed on top of the holder 12 while the magnetic attraction device 2 is disposed to the holder 12 relatively to the lower end of the light-emitting unit 11. Accordingly, the magnetic attraction device 2 secures the lighting fixture 1 onto the metallic surface for easy access by the user. A head strap 4 may be provided as illustrated in FIG. 10 to help secure the lighting fixture 1 on a work helmet 5 the user wears.

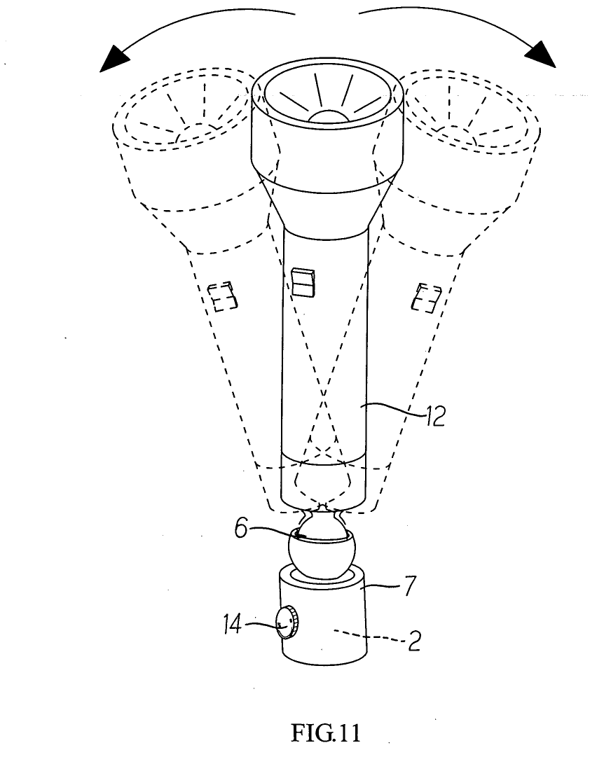

As illustrated in FIG. 11, a universal connector 6 and a base 7 are further provided to the lower end of the holder 12, i.e., the bottom cap of a flashlight, with the magnetic attraction device 2 disposed in the base 7 for the magnetic attraction device 2 to hold the lighting fixture 1 in place when the base 7 is placed on the metallic surface; and the lighting fixture 1 swivels to a better angle as desired by the user by rotating the universal connector 6 to permit wider lighting coverage.

The prevent invention provides an improved structure of a lighting fixture, and the application for a utility patent is duly filed accordingly. However, it is to be noted that the preferred embodiments disclosed in the specification and the accompanying drawings are not limiting the present invention; and that any construction, installation, or characteristics that is same or similar to that of the present invention should fall within the scope of the purposes and claims of the present invention.

I claim:

1. An improved construction of a lighting fixture includes a light-emitting unit and a holder; the holder containing a cell to supply power to the light-emitting unit; a magnetic attraction device being disposed at where appropriately to the holder; the magnetic attraction device including magnetic member, magnetism permeable member, non-magnetism permeable member and control member; the magnetic member related to a permanent magnet; and the control member controls the direction of multiple magnetic force lines from the magnetic member to decide if the magnetism permeable member carries magnetic force or not.

2. An improved construction of a lighting fixture includes a light-emitting unit and a holder; the holder containing a cell to supply power to the light-emitting unit; a magnetic attraction device being disposed at where appropriately to the holder; the magnetic attraction device including magnetic member, magnetism permeable member, non-magnetism permeable member and control member; the magnetic member related to a permanent magnet; and the control member controls the magnet member to contact or not to contact the magnetism permeable member to decide if the magnetism permeable member carries magnetic force or not.

3. The improved construction of a lighting fixture of claim 1, wherein the lighting fixture is related to a flashlight and the magnetic attraction device is disposed at a bottom cap of the holder of the flashlight.

4. The improved construction of a lighting fixture of claim 2, wherein the lighting fixture is related to a flashlight and the magnetic attraction device is disposed at a bottom cap of the holder of the flashlight.

5. The improved construction of a lighting fixture of claim 1, wherein the lighting fixture is related to a flashlight, and the magnetic attraction device is disposed at the bottom cap or on one side of the holder of the flashlight.

6. The improved construction of a lighting fixture of claim 1, wherein the lighting fixture relates to a flashlight; the light-emitting unit is disposed to the head cap or on one side of the holder to respectively emit light directly ahead or sideway.

7. The improved construction of a lighting fixture of claim 2, wherein the lighting fixture relates to a flashlight; the light-emitting unit is disposed to the head cap or on one side of the holder to respectively emit light directly ahead or sideway.

8. The improved construction of a lighting fixture of claim 1, wherein the non-magnetism permeable member is disposed between two magnetism permeable members to separate them apart from each other; the magnetic member is also disposed between those two magnetism permeable member; the size of the magnetic member allows it to further expand into both magnetism permeable members; the controller member is fixed to the magnetic member and to a knob externally provided to the holder; and rotation of the knob controls the turning of the magnetic member to change the direction of those magnetic force lines to decide when the magnetism permeable member carries magnetic force or not.

9. The improved construction of a lighting fixture of claim 2, wherein the magnetism permeable member is disposed between two non-magnetism permeable members; and the magnetic member is transposed by the control member to laterally travel between the magnetism permeable member and both non-magnetism permeable members.

10. The improved construction of a lighting fixture of claim 9, wherein the control member includes a push key, a push rod, and a coil provides externally to the hold; on end of the push rod is connected to the push key; another end of the push rod is connected to the magnetic member; and the coil is disposed to the magnetic member at where on the opposite side of the push rod.

11. The improved construction of a lighting fixture of claim 1, wherein the lighting fixture is made in a square form; the light-emitting unit is disposed on the top of the holder; and the magnetic attraction device is disposed to the holder at where in relation to the lower end of the light-emitting unit.

12. The improved construction of a lighting fixture of claim 2, wherein the lighting fixture is made in a square form; the light-emitting unit is disposed on the top of the holder; and the magnetic attraction device is disposed to the holder at where in relation to the lower end of the light-emitting unit.

13. The improved construction of a lighting fixture of claim 1, wherein a universal connector and a base are disposed to the lower end of the holder of the lighting fixture, and the magnetic attraction device is disposed in the base.

14. The improved construction of a lighting fixture of claim 2, wherein a universal connector and a base are disposed to the lower end of the holder of the lighting fixture, and the magnetic attraction device is disposed in the base.
